(19) United States
(12) Patent Application Publication
(10) Pub. No.: US 2025/0132103 A1
(43) Pub. Date: Apr. 24, 2025

(54) SYSTEM AND METHOD FOR PREPARING SUPERCAPACITORS UTILIZING THREE-DIMENSIONAL HIERARCHICAL POROUS NITROGEN-DOPED REDUCED GRAPHENE-OXIDE

(71) Applicants: KOREA INSTITUTE OF SCIENCE AND TECHNOLOGY, Seoul (KR); KUMAUN UNIVERSITY, Nainital (IN)

(72) Inventors: Yong Chae JUNG, Wanju-gun (KR); Youngnam KIM, Wanju-gun (KR); Chetna TEWARI, Wanju-gun (KR); Nanda Gopal SAHOO, Nainital (IN); Mayank PATHAK, Nainital (IN); Rajesh Chandra BHATT, Nainital (IN); Diksha BHATT, Nainital (IN)

(73) Assignees: KOREA INSTITUTE OF SCIENCE AND TECHNOLOGY, Seoul (KR); KUMAUN UNIVERSITY, Nainital (IN)

(21) Appl. No.: 18/920,393

(22) Filed: Oct. 18, 2024

(30) Foreign Application Priority Data
Oct. 18, 2023 (IN) 202311070819

(51) Int. Cl. H01G 11/44; C01B 32/198; C01B 32/21; H01G 11/86

(52) U.S. Cl. CPC H01G 11/44; C01B 32/198; C01B 32/21; H01G 11/86; C01B 2204/22; C01P 2002/82; C01P 2002/85; C01P 2002/88; C01P 2004/03; C01P 2004/04; C01P 2006/40

(57) ABSTRACT

The method comprises separating the outer green rind the room aloe vera leaf thereby cleaning and drying in sunlight for two days followed by oven drying at 80° C. for about 24 hours; pyrolyzing the dried outer green rind in an inert environment of N2 gas at 400° C. for about 1 hour to obtain a pre-carbonized carbon (AV-C); mixing the AV-C with K2CO3 in a 2:1 impregnation ratio to obtain a mixture;; pyrolyzing the mixture of the AV-C and K2CO3 at 900° C.; removing resulting black charred residue and cleaning the resulting charred residue with double-distilled water and isopropyl alcohol; homogenizing the cleaned black material of reduced graphene oxide using an ultrasonic homogenizer at 30% power for 1 hour with 10 pulse rates thereby drying and filtering the reduced graphene oxide to obtain 3D-HPN-rGO; h) preparing an electrode using the obtained 3D-HPN-rGO; and i) constructing a supercapacitor device using the electrodes.

### CROSS REFERENCE TO RELATED APPLICATION

The present application claims priority to Indian patent application Ser. No. 20/231,1070819, filed Oct. 18, 2023, the entire contents of which is incorporated herein for all purposes by this reference.

### BACKGROUND OF THE INVENTION

### Field of the Invention

The present invention relates generally to the field of energy storage devices, and more particularly to the preparation of supercapacitors. Specifically, the invention concerns a system and method for fabricating supercapacitors that utilize a three-dimensional hierarchical porous nitrogen-doped reduced graphene-oxide derived from Aloe vera leaves.

### Description about National Research and Development Support

This study was supported by the technology development programs of Ministry of Science and ICT, Republic of Korea (Projects No. 1711188974 and No. 1711202568) under the Korea Institute of Science and Technology.

The innovation of trustworthy, efficient, and sustainable energy sources free of pollution is the crucial solution to compact with the increasing energy demand, exhaustion of fossil fuels, and exploring major environmental and health concerns. To assuage the effects of environmental concerns, a new advent of eco-friendly energy storage devices must be placed in our existing energy storage technologies. Supercapacitors, also known as ultracapacitors or electrochemical capacitors, have gained significant attention as energy storage devices due to their high power density, fast charge/discharge rates, and long cycle life. These characteristics make them ideal for various applications, including portable electronics, electric vehicles, and renewable energy systems. Using their charge storage mechanics as a basis, the SCs are divided into two categories i.e., Pseudocapacitors (PCs) and Electric double-layer capacitors (EDLCs). EDLCs work on the ion adsorption/desorption phenomenon, while pseudocapacitors are based upon fast Faradaic reactions. Transition metal oxides/halides (i.e., Fe304, MnO2, Cu2O3, TiO2, V2O5, etc.), heavy metals, and their halides/oxides are used as the electrode material in PCs. However, in EDLCs different carbon materials viz. carbon aerogels, carbon nanomaterials (CNMs) such as graphene, carbon nanotubes (CNTs), etc., act as active materials for the fabrication of the electrodes. Graphene-based materials seem to be the most promising candidate as the electrode material for energy storage applications due to a distinct two-dimensional structure, better electron mobility, high conductivity, and high specific theoretical surface area (2630 m2/g). Other intriguing characteristics include lightweight properties, superior chemical stability, and flexibility, which are all driving the race to build new-generation supercapacitors.

In recent years, there has been a growing interest in utilizing renewable resources for the development of advanced electrode materials. This interest is driven by the need for sustainable and eco-friendly energy storage solutions. Recently, bio-derived graphene-based materials have been employed as a high-performance supercapacitor application due to their intrinsic and extrinsic characteristics such as high electronic conductivity, high surface area, low cost, affordability to large-scale applications, and easy synthesis methods. The biomass-derived activated carbon synthesis is an efficient way to prepare low-cost nano-porous carbon materials by controlling the chemical activation rather than complex methods of porous carbon preparation. To date, various biomass/bio-waste materials have been extensively studied to ameliorate the energy storage materials prospect with low cost. The carbonization and activation processes can be optimized to create a hierarchical pore structure, including micropores and mesopores, which enhance ion diffusion and electrolyte accessibility. This hierarchical pore structure contributes to the high capacitance and fast charge/discharge rates of the supercapacitor electrodes. The carbonization process can be tailored to enhance the graphitic nature of the carbon, leading to improved electrical conductivity, and enhanced electrochemical performance. The energy density of the supercapacitor mainly depends on the specific capacitance and cell voltage. In aqueous-based electrolytes, the cell voltage is limited due to the decomposition of water at 1.23V; organic and ionic liquid-based electrolytes have a higher potential window that will improve the energy density of the supercapacitor significantly, but they are of high cost and non-environment friendly.

Aloe vera, a widely cultivated succulent plant that belongs to the family Liliaceae, is one of the most widely used medicinal plants across the globe and has emerged as a promising candidate for the synthesis of carbon-based materials due to its abundance, low cost, and favorable properties. Furthermore, aloe-vera-derived carbon-based materials possess excellent electrical conductivity, allowing for efficient electron transport during the charge/discharge process. Here, an efficient route is demonstrated to prepare graphene-based material from aloe plant leaf (Aloe-vera) and its potential application in electrochemical supercapacitors as electrode material. To the best of our knowledge, for the first time, the graphene-based material from aloe vera leaf via a green synthesis route and explored their potential applications in supercapacitors. The resulting aloe-vera-derived carbon materials exhibit unique properties that make them attractive for supercapacitor applications. Also, we've used aloe gel as a natural green electrolyte which is of low cost, environment friendly, and has a higher potential window than existing aqueous electrolytes. Till now none of such inventions have been reported yet, with such an eco-friendly nature, low cost, and green synthesis route for the production of highly porous graphene-based material from aloe-vera leaves and aloe gel natural green electrolyte with that much potential window for futuristic ultracapacitors application prospectus.

Overall, aloe-vera-derived carbon nanomaterials hold significant promise as electrode materials for supercapacitor applications. Their unique combination of high specific surface area, excellent electrical conductivity, and hierarchical pore structure makes them attractive for energy storage devices. Along with this, aloe vera gel emerged as a novel green electrolyte for supercapacitor application with a high potential window of up to 1.8V. Additionally, their utilization promotes the use of renewable resources and supports the development of sustainable energy technologies.

In view of the foregoing discussion, it is portrayed that there is a need to have a system and method for fabricating supercapacitors that utilize a three-dimensional hierarchical porous nitrogen-doped reduced graphene-oxide derived from Aloe vera leaves.

### SUMMARY OF THE INVENTION

The present disclosure seeks to provide a three-dimensional hierarchical porous nitrogen-doped reduced graphene oxide (3D-HPN-rGO) derived from aloe vera leaf that is utilized as an electrode material to create a high-performance supercapacitor (SC). The scanning electron microscope (SEM) and transmission electron microscope (TEM) images demonstrated the presence of pores formed after chemical activation at higher temperatures.

Aqueous electrolytes typically have a limited potential window, usually up to 1.2 V, which restricts the energy density of SC devices. However, in this work, no aqueous electrolyte is used; instead, naturally available aloe gel served as the electrolyte, offering an enhanced potential window of up to 1.8 V, significantly higher than any aqueous electrolyte. The synthesized nanomaterial is initially evaluated in a three-electrode setup, and then the fabricated device is characterized in a two-electrode setup. The SC device, employing aloe gel as the electrolyte and 3D-HPN-rGO as the electrode material, demonstrated a high specific capacitance of 212.67 Fg-1 and an energy density of 23.92 Whkg-1 at a current density of 0.2 Ag-1. Moreover, the SC device exhibited remarkable stability even after 5000 charge-discharge cycles. The combination of aloe vera-derived 3D-HPN-rGO as an electrode material and aloe gel as the electrolyte in the SC device provides valuable insights into the potential use of naturally available, environmentally friendly substances as components for future energy storage devices.

In an embodiment, a method for preparing supercapacitors utilizing three-dimensional hierarchical porous nitrogen-doped reduced graphene oxide (3D-HPN-rGO) derived from aloe vera leaf is disclosed. The method includes processing raw aloe vera leaf and separating an aloe vera leaf into an inner gel and an outer green rind. The method further includes cleaning and drying the outer green rind in sunlight for two days followed by oven drying at 80° C. for about 24 hours. The method further pyrolyzing the dried outer green rind in an inert environment of N2 gas using a Tube furnace apparatus at 400° C. for about 1 hour to obtain a pre-carbonized carbon (AV-C) by pre-carbonization. The method further mixing the AV-C with K2CO3 in a 2:1 impregnation ratio to obtain a mixture. The method further pyrolyzing the mixture of the AV-C and K2CO3 at a temperature of 900° C. in an inert environment of N2 gas. The method further removing the resulting black charred residue once the Tube furnace apparatus is cooled and cleaning the resulting charred residue with double-distilled water and isopropyl alcohol. The method further homogenizing the cleaned black material of reduced graphene oxide with ultrasonic energy using an ultrasonic homogenizer at 30% power for 1 hour with 10 pulse rates thereby drying and filtering the reduced graphene oxide to obtain 3D-HPN-rGO. The method further preparing an electrode using the obtained 3D-HPN-rGO. The method further constructing a supercapacitor device using the electrodes.

In another embodiment, a system for preparing supercapacitors utilizing three-dimensional hierarchical porous nitrogen-doped reduced graphene oxide (3D-HPN-rGO) derived from aloe vera leaf is disclosed. The system includes a pre-processing unit configured to separate the Aloe vera leaf into an inner gel component and an outer green rind component. The system further includes a drying unit coupled to the pre-processing unit to subject the outer green rind component to a drying process under sunlight followed by oven drying at 80° C. The system further includes a tube furnace apparatus in connection with the drying unit to perform a two-step pyrolysis process on the dried outer green rind. The system further includes a mortar and pestle in continuation with a tube furnace apparatus adapted for grinding resultant pyrolyzed material to a fine black powder. The system further includes a mixing unit configured to combine the black powder with K2CO3 in a 2:1 impregnation ratio. The system further includes an ultrasonic homogenizer coupled to the mixing unit to treat the resultant black material at 30% power for 1 hour with 10 pulse rates to produce 3D-HPN-rGO. The system further includes a coating unit connected to the ultrasonic homogenizer to apply a 10-weight percent PVDF binder in N-methyl pyrrolidone (NMP) solvent onto at least two graphite sheets. The system further includes a drying unit coupled to the coating unit to allow the coated graphite sheets to dry for 24 hours in an oven set at around 600° C. The system further includes an electrode configuration unit in connection to the drying unit to separate coated material on two graphite sheets by a Millipore filter paper submerged in Aloe vera gel electrolyte to fabricate a supercapacitor.

An object of the present disclosure is to develop a novel three-dimensional hierarchical porous nitrogen-doped reduced graphene oxide (3D-HPN-rGO) synthesized from aloe vera leaves as a promising electrode material for supercapacitors.

Another object of the present disclosure is to develop a unique three-dimensional hierarchical porous nitrogen-doped reduced graphene oxide (3D-HPN-rGO) derived from aloe vera leaves through a two-step pyrolysis technique, followed by activation.

Yet another object of the present invention is to deliver an expeditious and cost-effective method for preparing supercapacitors utilizing three-dimensional hierarchical porous nitrogen-doped reduced graphene oxide (3D-HPN-rGO) derived from aloe vera leaf.

To further clarify the advantages and features of the present disclosure, a more particular description of the invention will be rendered by reference to specific embodiments thereof, which are illustrated in the appended drawings. It is appreciated that these drawings depict only typical embodiments of the invention and are therefore not to be considered limiting of its scope. The invention will be described and explained with additional specificity and detail in the accompanying drawings.

### BRIEF DESCRIPTION OF THE DRAWINGS

These and other features, aspects, and advantages of the present disclosure will become better understood when the following detailed description is read concerning the accompanying drawings in which like characters represent like parts throughout the drawings, wherein:

FIG. 1 illustrates a block diagram of a system for preparing supercapacitors utilizing three-dimensional hierarchical porous nitrogen-doped reduced graphene oxide (3D-HPN-rGO) derived from aloe vera leaf;

FIG. 2 illustrates a flow chart of a method for preparing supercapacitors utilizing three-dimensional hierarchical porous nitrogen-doped reduced graphene oxide (3D-HPN-rGO) derived from aloe vera leaf;

FIG. 3 illustrates a process flow of a method for the synthesis of 3D-HPN-rGO from Aloe vera leaves;

FIG. 4 illustrates a schematic diagram of a three-electrode system;

FIG. 5 illustrates the fabrication process of the supercapacitor device;

FIG. 6 illustrates A, B: FT-IR spectra of 3D-HPN-rGO and AV-900 C RAMAN spectra of 3D-HPN-rGO D TGA of 3D-HPN-rGO and AV-900;

FIG. 7 illustrates A, B, & C: SEM images of 3D-HPN-rGO D Hill stack view of SEM image for surface roughness;

FIG. 8 illustrates A, B, C & D: TEM images of 3D-HPN-rGO;

FIG. 9 illustrates a map spectrum of 3D-HPN-rGO obtained via EDX;

FIG. 10 illustrates an LSV test for A AV-900 and B 3D-HPN-rGO;

FIG. 11 illustrates A & C: CV plots at numerous scan rates, B & E: GCD plots at different current densities for AV-900 and 3D-HPN-rGO respectively, C Using a sinusoidal signal of 10 mV and a frequency range of 1 MHz to 10 mHz (Nyquist plot), and D a closer view of Nyquist plot;

FIG. 12 illustrates A: CV plots at numerous potential windows with a scan rate of 50 mVs-1, B: CV plots at numerous scan rates, C: GCD plots at different current densities, D Nyquist plots, a closer look of EIS plot, and equivalent circuit of model SC, E: Cyclic stability in terms of Cs value, and F Cyclic stability in terms of percentage capacitance retention, both at 0.3 Ag-1 current density for 3D-HPN-rGO respectively;

FIG. 13 illustrates Table 1 depicts an elemental analysis of the sample via EDX;

FIG. 14 illustrates Table 2 depicts Cs values of electrode materials at numerous scan rates employing a CV;

FIG. 15 illustrates Table 3 depicts Cs values of electrode materials at different current densities employing a GCD;

FIG. 16 illustrates Table 4 depicts Specific Capacitance values at numerous scan rates in two electrode setups; and

FIG. 17 illustrates Table 5 depicts Specific Capacitance values at numerous current densities in two electrode setups.

Further, skilled artisans will appreciate those elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION OF THE INVENTION

To promote an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail concerning the accompanying drawings.

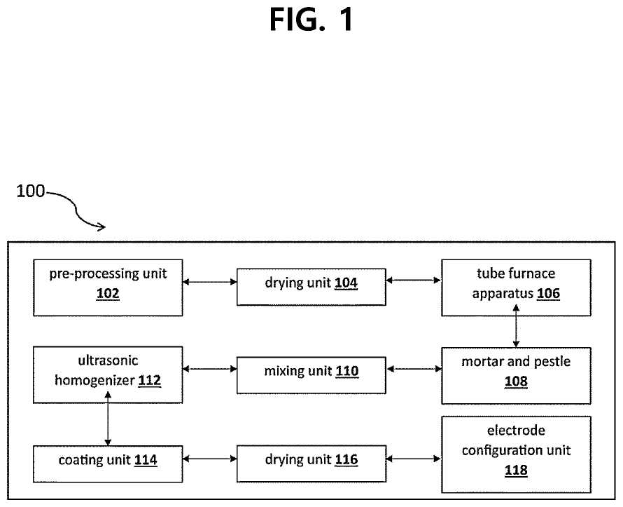

Referring to FIG. 1, a block diagram of a system for preparing supercapacitors utilizing three-dimensional hierarchical porous nitrogen-doped reduced graphene oxide (3D-HPN-rGO) derived from aloe vera leaf is illustrated in accordance with an embodiment of the present disclosure. The system 100 includes a pre-processing unit configured to separate the Aloe vera leaf into an inner gel component and an outer green rind component.

In an embodiment, a drying unit is coupled to the pre-processing unit to subject the outer green rind component to a drying process under sunlight followed by oven drying at 80° C.

In an embodiment, a tube furnace apparatus is in connection with the drying unit to perform a two-step pyrolysis process on the dried outer green rind.

In an embodiment, a mortar and pestle are in continuation with a tube furnace apparatus adapted for grinding resultant pyrolyzed material to a fine black powder.

In an embodiment, a mixing unit is configured to combine the black powder with K2CO3 in a 2:1 impregnation ratio.

In an embodiment, an ultrasonic homogenizer is coupled to the mixing unit to treat the resultant black material at 30% power for 1 hour with 10 pulse rates to produce 3D-HPN-rGO.

In an embodiment, a coating unit is connected to the ultrasonic homogenizer to apply a 10-weight percent PVDF binder in N-methyl pyrrolidone (NMP) solvent onto at least two graphite sheets.

In an embodiment, a drying unit is coupled to the coating unit to allow the coated graphite sheets to dry for 24 hours in an oven set at around 600° C.

In an embodiment, an electrode configuration unit is in connection to the drying unit to separate coated material on two graphite sheets by a Millipore filter paper submerged in Aloe vera gel electrolyte to fabricate a supercapacitor.

In another embodiment, the tube furnace apparatus operates at a heating rate of 50° C./min during the first step of pyrolysis to reach a temperature of 400° C. in an inert environment of N2 gas, whereas the second step of pyrolysis in the tube furnace apparatus operates at a fast-heating rate of 10° C./min to reach a temperature of 900° C. in an N2 environment.

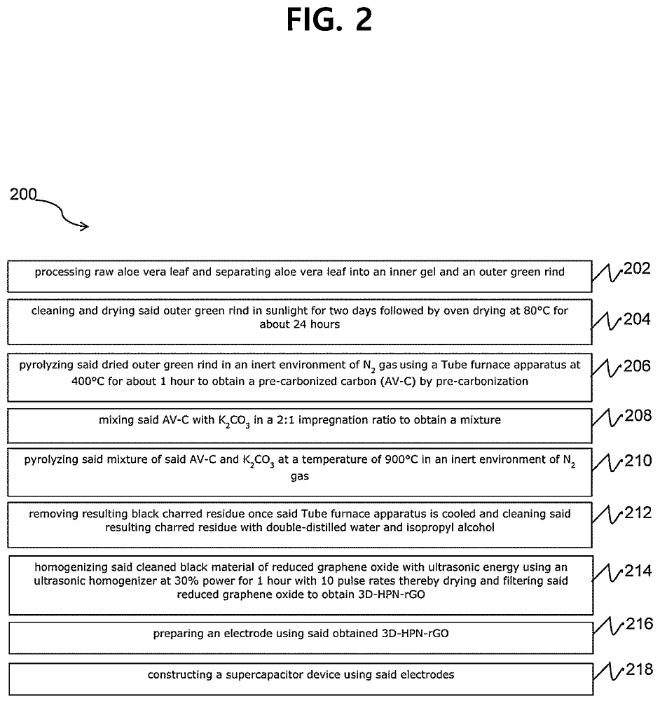

FIG. 2 illustrates a flow chart of a method for preparing supercapacitors utilizing three-dimensional hierarchical porous nitrogen-doped reduced graphene oxide (3D-HPN-rGO) derived from aloe vera leaf. At step 202, method 200 includes processing raw aloe vera leaf and separating aloe vera leaf into an inner gel and an outer green rind.

At step 204, method 200 includes cleaning and drying the outer green rind in sunlight for two days followed by oven drying at 80° C. for about 24 hours.

At step 206, method 200 includes pyrolyzing the dried outer green rind in an inert environment of N2 gas using a Tube furnace apparatus at 400° C. for about 1 hour to obtain a pre-carbonized carbon (AV-C) by pre-carbonization.

At step 208, method 200 includes mixing the AV-C with K2CO3 in a 2:1 impregnation ratio to obtain a mixture.

At step 210, method 200 includes pyrolyzing the mixture of the AV-C and K2CO3 at a temperature of 900° C. in an inert environment of N2 gas.

At step 212, method 200 includes removing the resulting black charred residue once the Tube furnace apparatus is cooled and cleaning the resulting charred residue with double-distilled water and isopropyl alcohol.

At step 214, method 200 includes homogenizing the cleaned black material of reduced graphene oxide with ultrasonic energy using an ultrasonic homogenizer at 30% power for 1 hour with 10 pulse rates thereby drying and filtering the reduced graphene oxide to obtain 3D-HPN-rGO.

At step 216, method 200 includes preparing an electrode using the obtained 3D-HPN-rGO.

At step 218, method 200 includes constructing a supercapacitor device using the electrodes.

In another embodiment, processing raw aloe vera leaf comprises steps of cutting the raw aloe vera leaf into small pieces. Then, washing the small pieces repeatedly with DI. Thereafter, slicing the small pieces into two parts, and collecting the Aloe vera gel from both sides to separate the aloe vera leaf into the inner gel and the outer green rind.

In another embodiment, the pyrolyzing in step c involves gradually pyrolyzing the sample at a heating rate of 50° C./min to remove liquid and gaseous components, whereas the pyrolyzing in step e involves a heating rate of 10° C./min.

In another embodiment, the pre-carbonization of the sample establishes a framework for an Aloe vera-derived rGO with a separation of liquids and gases followed by obtaining a black-colored solid after 1 hour of pyrolysis and cooling the Tube furnace apparatus to ambient temperature to extract black material thereby reducing the black material to a fine powder using a mortar and pestle to obtain the AV-C.

In another embodiment, preparing the electrode using the synthesized 3D-HPN-rGO comprising the steps of preparing a paste by mixing 3D-HPN-rGO with 10 wt % PVDF binder dissolved in N-Methyl-2-pyrrolidone (NMP) solvent and mixing thoroughly with a stirrer. Then, coating graphite sheets with the paste. Then, drying the coated graphite sheets at 60° C. for about 24 hours.

In another embodiment, the coated material's weight on the graphite sheet before and after the coating procedure is measured to obtain a coated mass value of 1 mg.

In another embodiment, constructing a supercapacitor device comprising the steps of positioning two dried electrodes in a manner wherein the substance coating faces each other. Then, separating the two electrodes using a Millipore filter paper submerged in Aloe vera gel as an electrolyte.

In another embodiment, the synthesized 3D-HPN-rGO is used in a three-electrode system, wherein the working electrode is the Aloe-vera-derived reduced Graphene Oxide material coated on a graphite sheet, a reference electrode is Ag/AgCl, and a counter electrode is a Platinum wire.

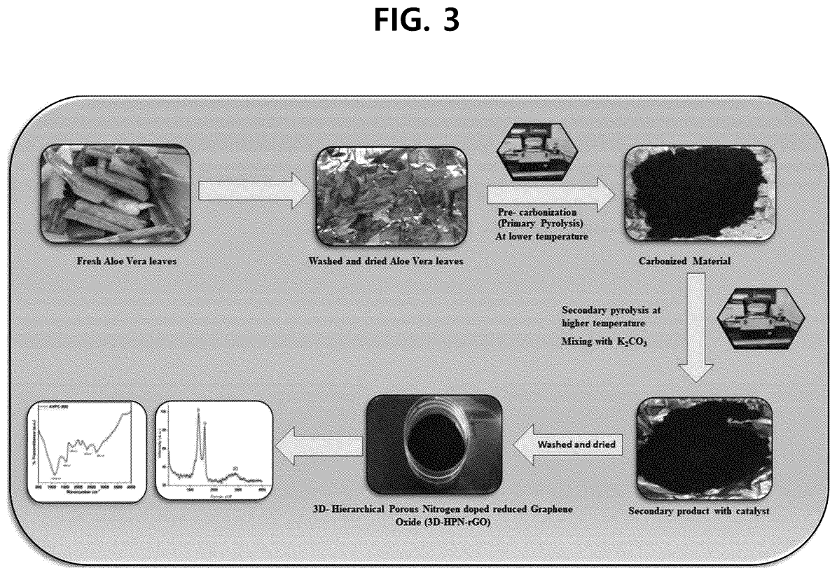

FIG. 3 illustrates a process flow of a method for the synthesis of 3D-HPN-rGO from Aloe vera leaves. Aloe vera plant leaves are collected from the local region of Nainital, Uttarakhand, India. K2CO3 is procured from Qualigens Fine Chemicals, Glaxo India Limited, Bombay, N-Methyl-2-pyrrolidone (NMP) from Sisco Research Laboratories Pvt. Ltd. (SRL), and polyvinylidene fluoride (PVDF) polymer is bought from Sigma Aldrich. While all the chemicals are employed exactly as they are given to us. The Madras Asbestos shop supplied the graphite sheets which are used as the current collector. Double distilled water is used in all the experiments.

### Synthesis of 3D-Hierarchical Porous Nitrogen-Doped Reduced Graphene Oxide (3D-HPN-rGO)

The Aloe vera leaf can be separated into two main sections, the inner colourless parenchyma containing the aloe gel (or inner pulp, mucilage tissue, mucilaginous gel, mucilaginous jelly, inner gel) and the outer green rind, which includes the vascular bundles. Technically speaking, “gel” or “mucilage” refers to the viscous transparent liquid found inside the parenchyma cells, while “pulp” or “parenchyma tissue” refers to the complete fleshy inner section of the leaf, including the cell walls and organelles.

After cutting into small pieces and repeatedly washing with DI, the raw aloe vera leaf is sliced into two parts and the Aloe vera gel is from both sides. The Aloe vera leaf (outer green rind) is cleaned and dried in the sunlight for two days before being placed in an oven for 24 hours at 80° C. Here a two-step pyrolysis method is used to obtain Aloe vera-based reduced Graphene Oxide (rGO) can be shown in FIG. 3, together with other significant steps that are involved in the process of making 3D-Hierarchical Porous Nitrogen-doped reduced Graphene Oxide (3D HPN-rGO) from Aloe vera leaf. The first step is the pre-carbonization of dried Aloe vera leaf (outer green rind). The generated sample mixture is principally pyrolyzed using a Tube furnace apparatus for 1 hour at 4000 C in an inert environment of N2 gas. This step involves gradually pyrolyzing the sample at a heating rate of 50° C./min to remove all liquid and gaseous components. Due to the pre-carbonization of the sample, this step establishes the framework for the Aloe vera-derived rGO with the separation of other liquids and gases. The black-colored solid is obtained after 1 hour of pyrolysis and cooling the device to ambient temperature. As a result, the black material is received, with the aid of a mortar and pestle, this black material is reduced to a fine black powder and labeled as AV-C (Aloe vera derived pre-carbonized carbon) before the subsequent heating procedure. The powdered AV-C and K2CO3 are mixed in a 2:1 impregnation ratio with the aid of a mixer, with K2CO3 serving as an activator. This AV-C and K2CO3 combination is once more pyrolyzed in the same instrument during the secondary heating procedure at 900° C. at a fast-heating rate of 10° C./min in an environment of N2 (10 mL/min). Once the instrument has cooled, the black charred residue is removed and cleaned with double-distilled water before being cleaned with isopropyl alcohol to filter out any undesirable organic contaminants. Now, this cleaned black material is homogenized with ultrasonic energy using an ultrasonic homogenizer at 30% power for 1 hour with 10 pulse rates. To obtain the reduced graphene oxide, the ultrasonicated material is now dried, filtered, and labeled as 3D-HPN-rGO.

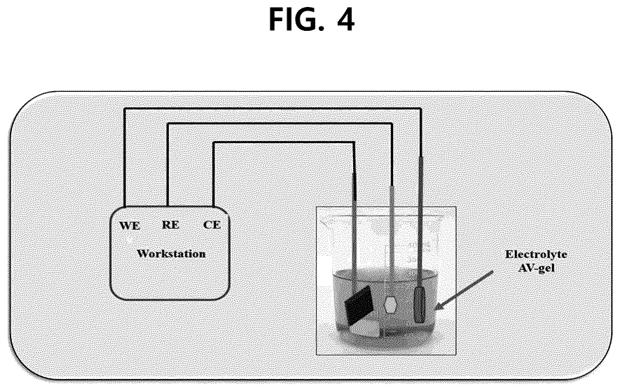

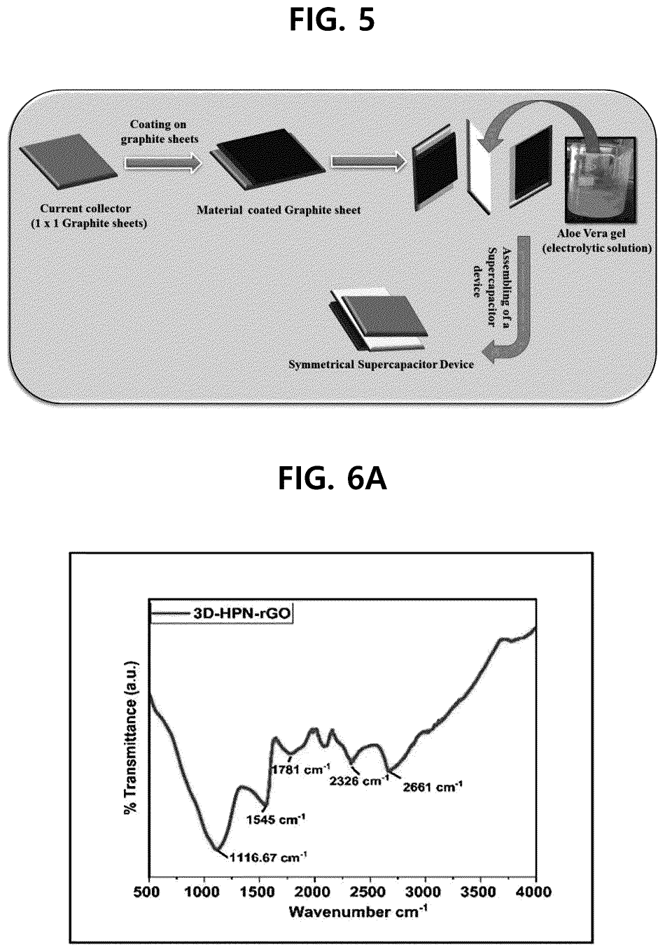

FIG. 4 illustrates a schematic diagram of a three-electrode system. The behavior of synthesized Aloe-vera-derived carbon materials (3D-HPN-rGO and AV-900) is investigated in the 35 three-electrode and symmetrical two-electrode system using Metrohm Autolab CV instrument, Aloe-vera gel used as a high voltage green electrolyte. Aloe-vera-derived reduced Graphene Oxide material coated on graphite sheet (1 cm×1 cm), Ag/AgCl, and Platinum wire are utilized as the working, reference, and counter electrodes for the three-electrode configuration, respectively FIG. 4. The identical procedure as in FIG. 5 is followed in the fabrication of the Supercapacitor device. In a 40 nutshell, the 10-weight percent PVDF binder in the sticky paste of the substance is dissolved in the N-methyl pyrrolidone (NMP) solvent is made by thoroughly mixing on a stirrer. Each graphite sheet (1 cm×1 cm) is individually coated which is then allowed to dry for 24 hours in the oven at 600.

The weight of the coated material on the graphite sheet is weighed both before and after the coating procedure to get the final coated mass value, which is 1 mg. When the electrodes are dry, they are positioned (facing each other) in such a way that the substance coating the two electrodes is separated by Millipore filter paper that had been submerged in Aloe-vera gel as an electrolyte to create the supercapacitor device.

FIG. 5 illustrates the fabrication process of the supercapacitor device.

### Material Characterization

Here, several characterization approaches are used to identify and validate the structural integrity of synthesized 3D HPN-rGO. With the aid of the well-known Raman spectroscopy, the vibrational characteristics of the synthesized materials are examined to characterize the generated 3D HPN-rGO using the HORIBA Japan Xplor Plus with an excitation beam length of 532 nm. For the surface morphology and elemental characterization of ZGNs, field emission scanning electron microscopy (FESEM) pictures are captured along with the Electron Dispersive X-ray (EDX) analysis using the Nova NanoSEM 450. Additionally, ImageJ software is utilized to assess the internal structure and surface morphologies of 3D HPN-rGO. Perkin Elmer's Spectrum-2 Fourier Transform Infrared Spectroscopy (FT-IR) instrument is utilized to precisely reveal several functionalities in synthesized material. Using Thermogravimetric Analysis (TGA) (Q500 V20.13 Build 39 Instruments), the sample's thermal stability is examined. Furthermore, the fabricated electrodes are characterized using a Metrohm Autolab electrochemical workstation.

### Electrochemical Characterization

The electrochemical workstation of Metrohm Autolab employed certain voltage ranges to characterize the fabricated electrodes using 3D HPN-rGO as the electrode material and aloe gel as the 20 electrolyte. The experiment electrodes are properly constructed using active material and PVDF-coated graphite sheets at a mass ratio of 90:10. The load mass of each electrode material coated on each single 1×1 cm2 graphite sheet is approximately 1 mg, and all electrochemistry experiments are conducted in aloe gel natural electrolyte. The well-prepared nanomaterial, platinum wire, and Ag/AgCl electrodes are chosen, respectively, as the working, counter, and reference electrodes in the three-electrode system. Galvanostatic charge-discharge (GCD) profiles, linear sweep voltammetry (LSV), and cyclic voltammetry (CV) curves are all recorded by the instrument. The Nyquist figure is obtained using the same equipment with an AC voltage amplitude of 10 mV and a frequency range of 1 MHz to 10 MHz. For cyclic voltammetry and galvanostatic charge-discharge, respectively, the area of the CV curves and discharge portion of the GCD curves in the three-electrode setup is utilized to calculate the gravimetric capacitances (Cs) as:

$${C}_{s} = \frac{A}{2 mk Δ v} \qquad ( 1 )$$

$${C}_{s} = \frac{l Δ t}{m Δ v} \qquad ( 2 )$$

To evaluate potential future applications, symmetric electrodes made of active material (3D HPN-rGO) of the same weight are built in the two-electrode system. The two-electrode configuration, as illustrated in FIG. 5, also made it possible to determine the gravimetric specific capacitance of the developed electrode materials using the corresponding CV and GCD equations:

$${C}_{s} = \frac{2 A}{mk Δ v} \qquad ( 3 )$$

$${C}_{s} = \frac{4 l Δ t}{m Δ v} \qquad ( 4 )$$

Where, I (A) is the discharging current, t (s) shows the duration of full discharging, m (g) is the loading amount of the active species, and V (V) represents the width of the potential window. The specific capacitance of the electrode materials is represented by Cs (Fg-1). The mass of the active material on the single working electrode is contained in equations (1) and (2), while equations (3) and (4) contain the masses of the active material from both electrodes, respectively. This is the difference between the equations for a three-electrode setup and a two-electrode setup.

The energy density (E, Whkg-1) and power density (P, Wkg-1) are the crucial factors in deciding the supercapacitor device's practical applicability for the desired application which are calculated using the following equations, respectively:

$$E = \frac{1}{2 \times 3.6} {C}_{s} {V}^{2} \qquad ( 5 )$$

$$P = \frac{E}{Δ t} \times 3600 \qquad ( 6 )$$

Where Cs (Fg-1) is the specific capacitance of the supercapacitor, V (V) is the useable potential window (excluding IR drop), and t (h) is the time for full discharge.

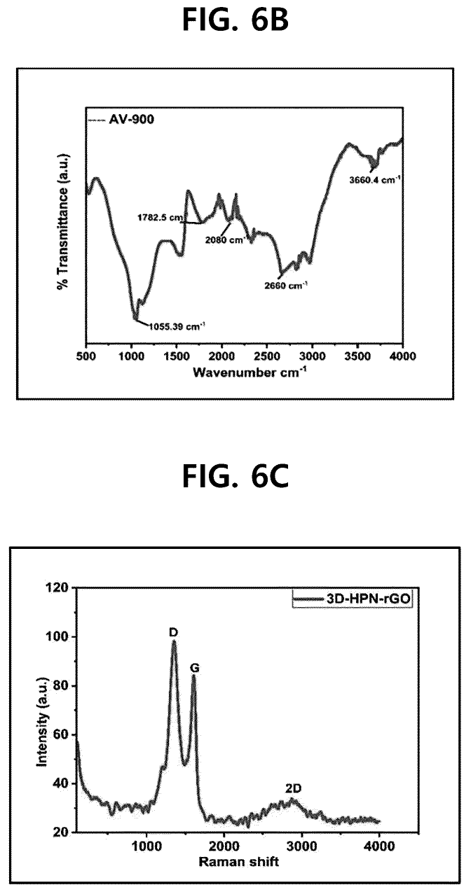

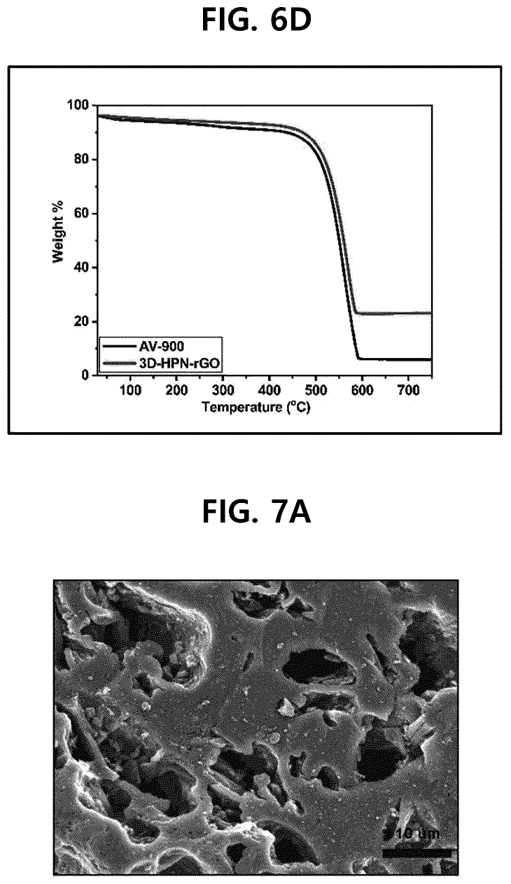

FIG. 6 illustrates A, B: FT-IR spectra of 3D-HPN-rGO and AV-900 C RAMAN spectra of 3D-HPN-rGO D TGA of 3D-HPN-rGO and AV-900.

### Structural and Morphological Studies

FT-IR analysis: To understand the nature of the synthesized material based on functional groups present in the prepared sample, the FT-IR spectrum is carried out. FIGS. 6A and 6B show the FT-IR spectra of the 3D-HPN-rGO and AV-900 samples respectively. The FT-IR spectra of AV-900 show peaks at 1055, 1782.5, 2080, 2660, and 3660.4 cm-1, and the FT-IR spectra of 3D-HPN-rGO show peaks at 1116.67, 1545, 1781, 2326 and 2661 cm-1respectively. In both the FT-IR spectra the peaks at 1055 and 1116.6 cm-1 correspond to C—O stretching, peaks at 1781, 1782.5 cm-1 arise due to C═O stretching vibrations of carboxylic groups, peaks at 2080, 2326 cm-1 corresponds to C═C stretching vibration of alkyne molecules, peaks at 2660, 2661 signifies the C—H stretching vibration of aldehyde molecules and peak at 3660.4 cm-1 in AV-900 arise due to O—H stretching vibration of alcohol molecules respectively. The absence of O-H stretching vibration peak is absent in 3D-HPN-rGO, indicating that it is thermally reduced at high temperatures. These peaks did not appear in the spectrum of graphite indicating that the synthesized material is rGO. By evaluating both the FT-IR spectra, it is clear that the surface properties of the 3D-HPN-rGO sample are modified and confirm the synthesis of exfoliated nitrogen-doped rGO.

RAMAN Analysis: RAMAN spectroscopy always remains a good tool to confirm the formation of graphene and its derivatives and to check the quality of synthesized material. FIG. 6C shows the RAMAN spectra of the 3D-HPN-rGO sample, which exhibit three vibrational peaks at 35 around 1359, 1606, and 2873 cm-1, corresponding to D, G, and 2D bands respectively. These peaks show the characteristic peaks for the rGO. In general, the D band is associated with disorder and defects in the hexagonal lattice of synthesized rGO nanosheets, and the G band is related to vibrations of sp2-bonded carbon atoms in a 2D hexagonal lattice and corresponds to the E2g phonon at the Brillouin zone center. The intensity ratio (IG/ID) can provide information on the disorder degree and the average size of the sp2 domains in graphitic materials, which can describe the structural changes during the chemical reactions. Because the D phonon mode is only optically active in the presence of disorder, it can provide a measure of the disorder of carbon species. The intensity ratio of D and G band, ID/IG is found to be 0.84, indicating a higher degree of disorder and a lower graphitization degree than natural graphite and graphene oxide (ID/IG=0.14 for natural graphite and, 0.8 for graphen oxide). This suggests the creation of a new graphitic domain for sp2 clusters with some defects in the 3D-HPN-rGO.

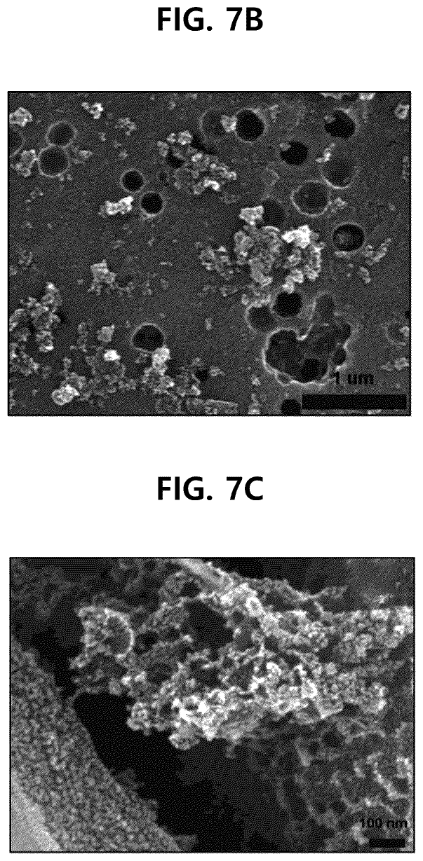

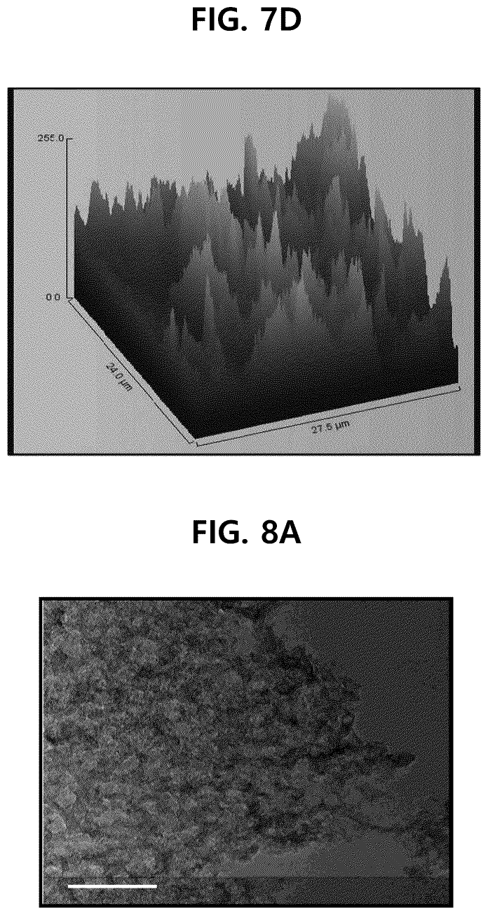

FIG. 7 illustrates A, B, & C: SEM images of 3D-HPN-rGO D Hill stack view of SEM image for surface roughness. SEM Analysis: SEM analysis is used to analyze the surface morphology of rGO synthesized from aloe vera plant leaves. FIG. 5 (a, b, & c) shows the SEM images of 3D-HPN-rGO at different magnifications, which confirm the arrangement of interconnected mesoporous structures throughout the sample along with the 53.04% surface porosity. These porous structures originate from the specific AV leaf and can be explained by the three following factors: (i) the retained abundant intrinsic pores in the AV leaf after washing and drying; (ii) the carbonization and graphitization of the AV leaf's organic materials during the pyrolysis process, which produces a rough, porous texture; and (iii) most importantly, the presence of K2CO3, which generates CO2 during high-temperature pyrolysis and make the surface porous. The above observation confirms that the K2CO3 activation of AV-derived carbon skeleton in the secondary pyrolysis process resulted in the formation of pores over the rGO materials which is essential for the electrolyte to access the entire surface for efficient charge storage and can enhance the available electrolyte contact area which further enables indefinitely rapid ion movement. The surface roughness of the confined region, with the help of the hill stack view, is shown in FIG. 7 D.

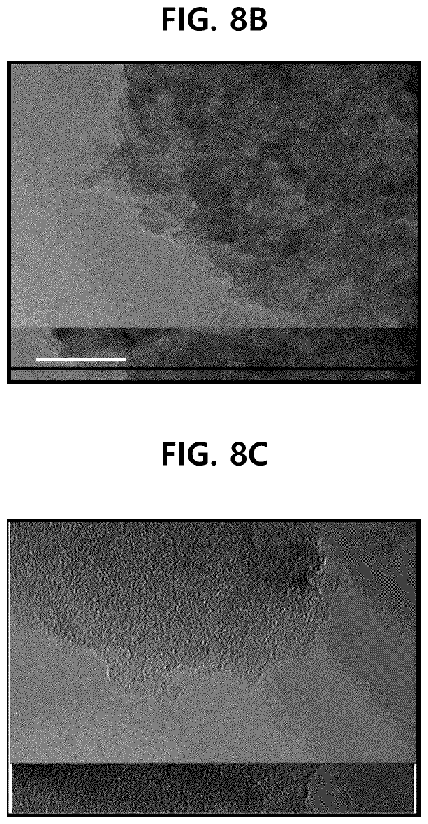

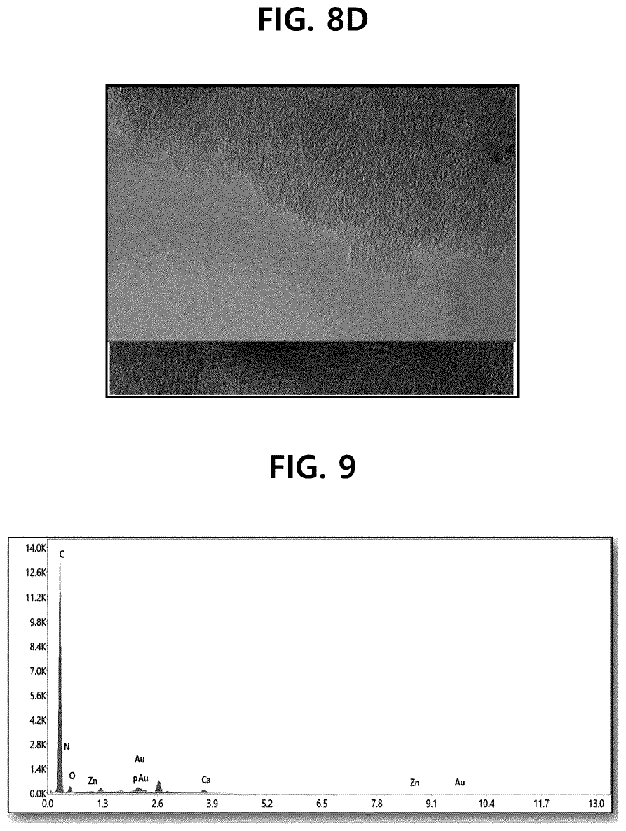

FIG. 8 illustrates A, B, C & D: TEM images of 3D-HPN-rGO. TEM analysis: TEM images are taken as shown in FIG. 8A, B, C & D to further confirm the interior morphology and structure of 3D-HPN-rGO. The mesopores on the surface of the carbon framework are visible in the TEM images of the 3D-HPN-rGO (FIG. 8a, b). Throughout K2CO3 activation, CO2 is produced during high-temperature pyrolysis and makes the surface highly porous. The aforementioned observation shows that the secondary pyrolysis process's K2CO3 activation of AV-derived carbon skeleton facilitated the emergence of pores over the rGO materials, which are necessary for the electrolyte to access the entire surface for efficient charge storage and can increase the available electrolyte contact area, allowing for even more unrestricted rapid ion movement.

FIG. 9 illustrates a map spectrum of 3D-HPN-rGO obtained via EDX.

TGA analysis: The thermal stability of AV-900 and 3D-HPN-rGO are evaluated by TGA analysis. FIG. 6D shows the TGA plot of AV-900 and 3D-HPN-rGO respectively. AV-900 and 3D-HPN-rGO display weight losses of approximately 15%, 10%, and 20% below 100° C., which can be attributed to the elimination of surface adsorbed water and moisture respectively. The AV-900 sample exhibits a significant weight loss between 420 and 580° C. as a result of the complete carbon decomposition in air. On the other hand, the 3D-HPN-rGO sample demonstrates a decomposition profile occurring at a slightly higher temperature range (550-650° C.) compared to that of AV-900. This might be explained by a high degree of graphitization or by the production of structurally homogeneous carbon atoms during high-temperature heat treatment. The whole breakdown of the sample without any residuals shows that there are no metal or metal oxide contaminants in the sample, only carbon.

EDX: With the assistance of EDX, elemental composition, and qualitative testing can be accomplished. According to the results in FIG. 9, 3D-HPN-rGO is majorly composed of Oxygen, Nitrogen, and Carbon. Further, Carbon and Oxygen are present in the sample as hexagonal rings and oxidative groups respectively while the nitrogen content and any other metal in 3D-HPN-rGO primarily depends on the N content of the precursor i.e. constituents of Aloe vera leaves. Additionally, Table 1 shows the percentages of carbon (87.1 wt %), Nitrogen (6.1 wt %), and oxygen (5.1 wt %).

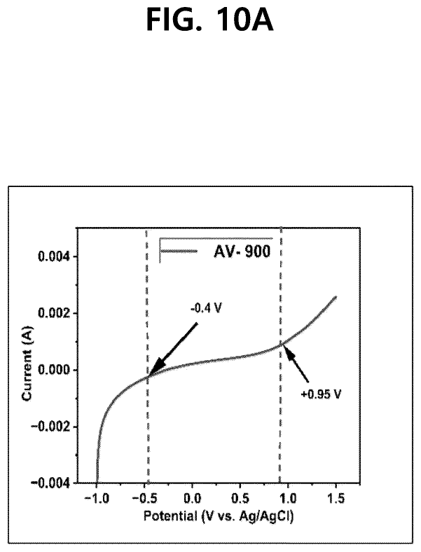

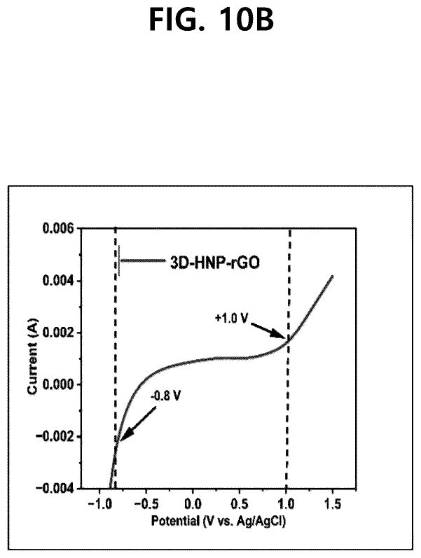

FIG. 10 illustrates an LSV test for A AV-900 and B 3D-HPN-rGO.

### Electrochemical Studies

Linear Sweep voltammetry (LSV), Cyclic voltammetry (CV), galvanostatic charge-discharge (GCD), and Electrochemical Impedance Spectroscopy (EIS) analyses are used to examine the electrochemical performance of the AV-900 and 3D-HPN-rGO material.

Linear sweep voltammetry (LSV): To determine the electrochemical potential window (EPW) of both materials over a three-electrode configuration in AV-gel green electrolyte, the LSV test is first taken into account. The abrupt increase in current that accompanied the voltage indicated that the potential range in that direction had been limited. The EPW for AV-900 electrode material is 1.35 V (+0.95 V on the positive side and −0.4 V on the negative side), whereas the EPW for 3D-HPN-rGOs electrode material effectively enhanced and reached up to 1.8 V (+1.0 V on the positive side and −0.8 V on the negative side) at a same scan rate of 50 mVs-1 respectively (FIG. 10 (a, b)). The CV and GCD experiments are carried out under the measured electrochemical potential window with the help of LSV, at numerous scan rates mainly in the range of 5-200 mVs-1 and at different current densities, respectively for 3D-HPN-rGO.

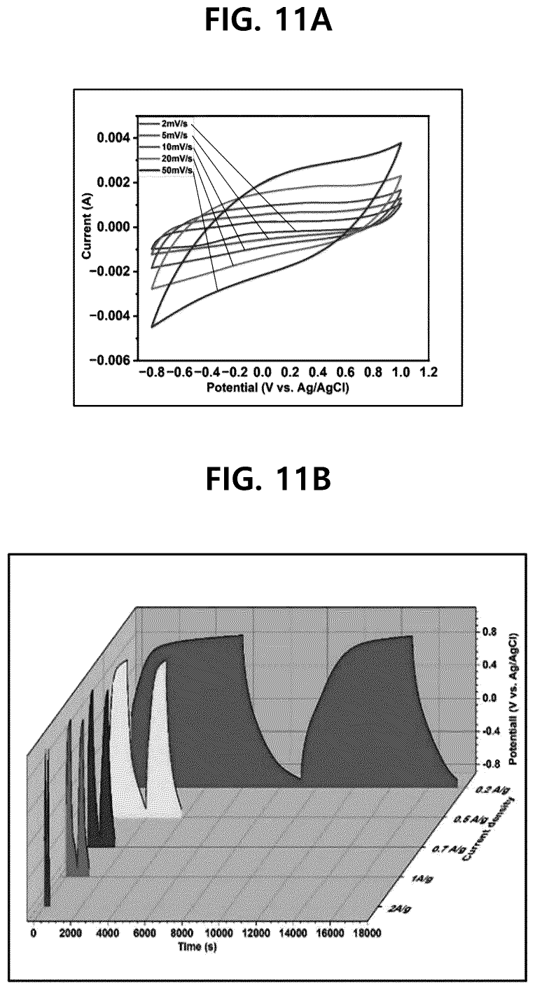

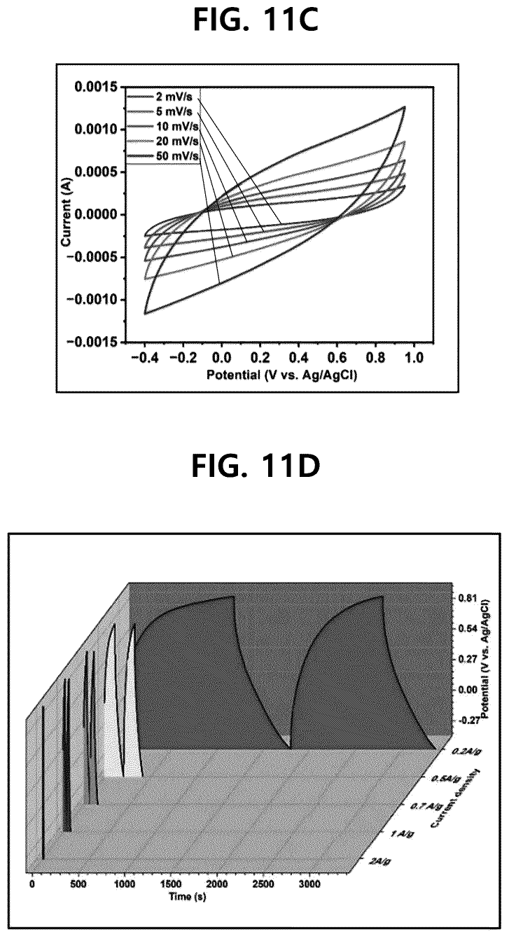

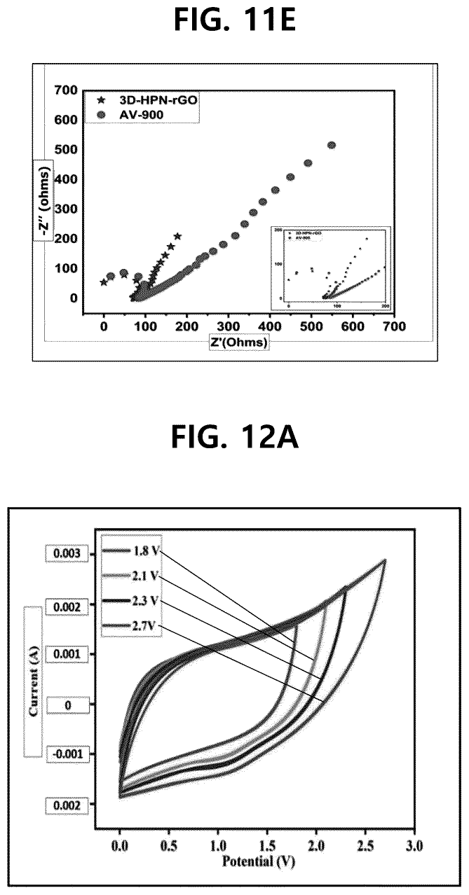

FIG. 11 illustrates A & C: CV plots at numerous scan rates, B & (2): GCD plots at different current densities for AV-900 and 3D-HPN-rGO respectively, C Using a sinusoidal signal of 10 mV and a frequency range of 1 MHz to 10 mHz (Nyquist plot), and D a closer view of Nyquist plot.

Cyclic voltammetry (CV): After fabricating three electrode-configuration using an Aloe-vera derived 3D-HPN-rGO material and Aloe vera gel used as the electrolyte, multiple cyclic voltammetry (CV) tests are carried out to evaluate the electrode material's electrochemical capabilities at numerous scan rates (2-200 mVs-1). The rectangular type of CV curves reveals the good capacitive behavior of the 3D-HPN-rGO supercapacitor electrode. The area under the CV curve and voltage is the largest for 3D-HPN-rGO FIG. 11A. Equation 1 can be used to get the specific gravimetric capacitance of the three-electrode configuration. For comparison purposes, the electrodes of the AV-900 are also prepared using the same methodology and the same green Aloe gel electrolyte, and their CV graph is also taken in FIG. 11 C. Table 2 displays the calculated values for specific capacitance at various scan rates, with the maximum value denoted in bold. The maximum specific capacitance value of 126.10 Fg-1 is observed for 3D-HPN-rGO while less than half of 3D-HPN-rGO's specific capacitance (49.5 Fg-1) is observed for AV-900 at 2 mVs-1, respectively. This enhanced value of Cs for 3D-HPN-rGO concerning AV-900 indicates the importance of using activating agent K2CO3.

Galvanostatic charge/discharge (GCD): GCD measurements are also performed for both the materials namely, 3D-HPN-rGO and AV-900 at different current densities, including 0.2, 0.5, 0.7, 1, and 2 Ag-1 with a current sweep of 10 mA and a voltage range of −0.8 to 1 V vs. Ag/AgCl for 3D-HPN-rGO and −0.4 to +0.95 V vs. Ag/AgCl for AV-900, respectively (FIGS. 11B & D). Using Equation 2, the specific capacitance from GCD curves for three-electrode-configurations may be calculated. Table 3 shows the capacitance values from GCD curves for 3D-HPN-rGO and AV-900 at various current densities in which, the highest value of specific capacitance is shown boldly. Less rate of diffusion and migration of ions across the electrodes and electrolytic contact results in a lower Cs value at high current densities. The Cs value is larger at lower current densities, indicating quicker ion diffusion and migration at the electrode and electrolyte interface. The high capacitance value in the case of 3D-HPN-rGO is caused by increased contact at the double-layer interface between the electrode and the electrolytes due to which, it achieves longer charge-discharge time spans at low current densities. The maximum Cs of 3D-HPN-rGO are observed around 269.01 Fg-1 at 0.2 Ag-1 current density while the maximum Cs of AV-900 are observed around 81.37 Fg-1 at the same current density of 0.2 Ag-1. These trends of capacitance values measured through GCD plots support the values obtained from the CV curves.

Electrochemical impedance spectroscopy (EIS): EIS is utilized mainly to analyze the material's internal resistance and different types of impedance, operating in the frequency range of 10 MHz to 106 Hz. A plot of the real (Z) and imaginary (Z″) impedances (ohms) for a Supercapacitor electrode material, given in FIG. 11E, and a rising pattern in the low-frequency region suggests that synthesized electrode materials exhibit capacitive behavior. The semi-circle region in the higher frequency range shows that the charge transfer interface of the electrode material is accountable for the combination's bulk resistance. A semicircle with a straight line at a 90° angle is typically shown on the Nyquist plot. The semicircle shows the charge transfer resistance (Rct) between the electrode and the electrolyte. The line caused by Warburg resistance cuts the real axis at the smallest angle, as can be seen by taking a closer look at the mid-frequency area (FIG. 11D), suggests that the about ion diffusion paths for electrolyte ions to the pores of the electrode surface. The value of the equivalent series resistance (ESR, Rs) is provided in the higher frequency region to assist in the visualization of the real axis intercept. Using an equivalent circuit model to understand the Nyquist plot, the values of ESR and Rs are also verified. The obtained value of Rs˜15.65 ohm for 3D-HPN-rGO and 16.59 ohm for AV-900, respectively. While the charge transfer resistance is also quite higher in the case of AV-900 concerning 3D-HPN-rGO.

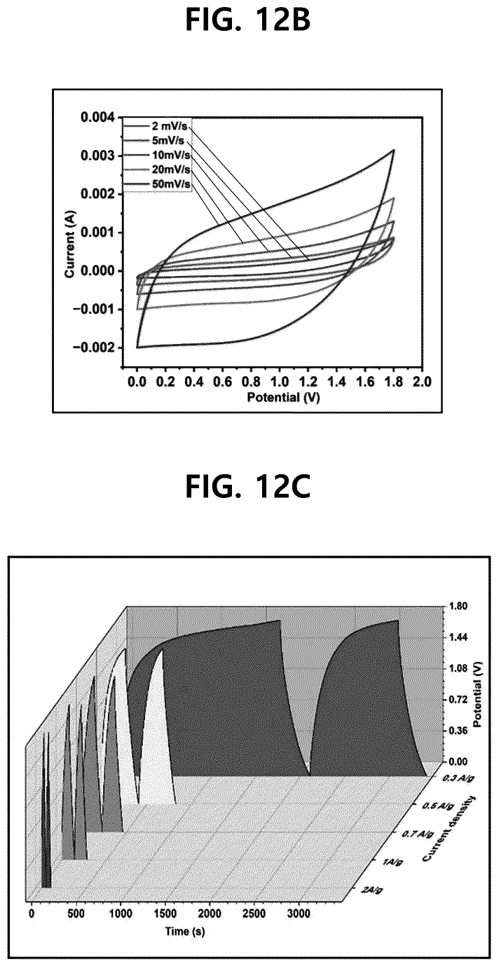

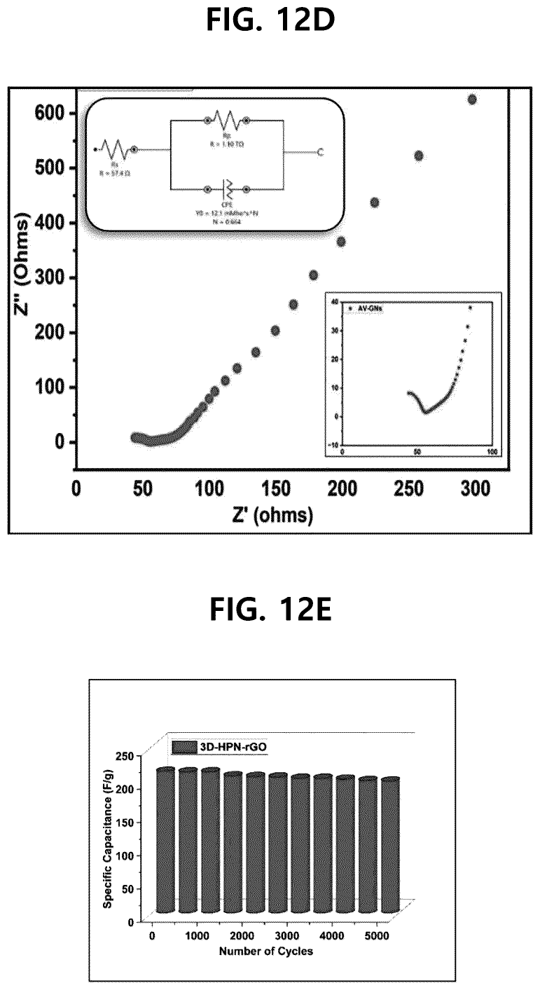

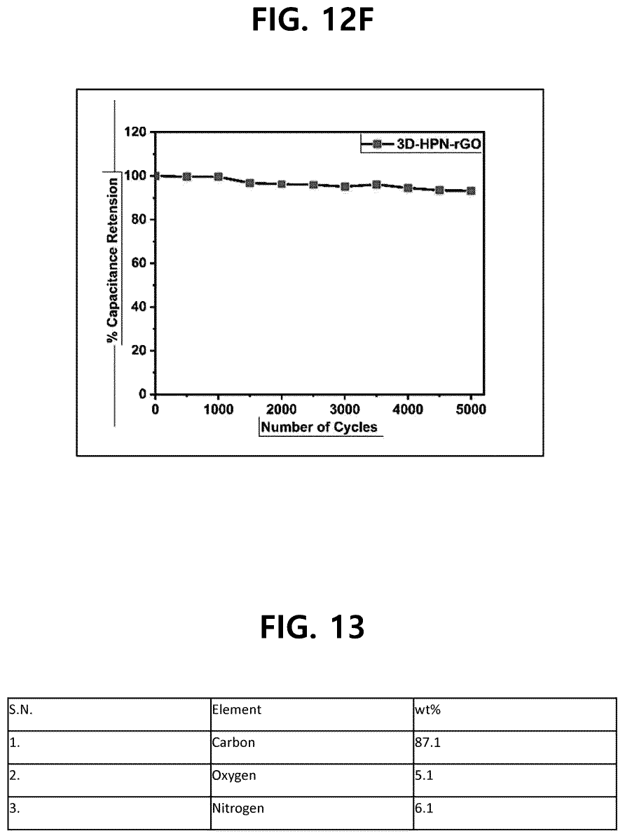

FIG. 12 illustrates A: CV plots at numerous potential windows with a scan rate of 50 mVs-1, B: CV plots at numerous scan rates, C: GCD plots at different current densities, D Nyquist plots, E a closer look of EIS plot, F equivalent circuit of model SC, G: Cyclic stability in terms of Cs value, and H Cyclic stability in terms of percentage capacitance retention, both at 0.3 Ag-1 current density for 3D-HPN-rGO respectively. After a complete comparison in CV, GCD, and EIS results of 3D-HPN-rGO and AV-900, 3D-HPN-rGO is found suitable to further proceed for the practical applicability so a model symmetric two-electrode device is fabricated to assess the potential use and practical application of 3D-HPN-rGO electrode material towards completely green supercapacitors in AV-gel (green electrolyte). In an electrolyte of AV--gel, the fabricated device with the symmetric electrodes is tested in the high potential range of 0 to 1.8 V. To obtain a suitable potential range for a Supercapacitor device, the CV curves at a fixed scan rate with changing potential (V) are performed as shown in FIG. 12A. The leaf shape of the CV profiles of the 3D-Hierarchical porous nitrogen-doped reduced Graphene Oxide (3D-HPN-rGO) at various scan rates represents the optimal capacitive behavior of electrode materials (FIG. 12 b). Equation 3 can be used to get the specific gravimetric capacitance of the electrode material in the two-electrode configuration using CV curves. The highest specific capacitance of 216.7 F/g at 2 mV/s is visible in the CV profile of the (3D-HPN-rGO) among other higher scan rates (Table 4).

Further, Equation 4 is used to compute the specific capacitance of the electrode from the charge-discharge profile. Meanwhile, the GCD results are in support of the CV results as the CD profiles of the 3D-HPN-rGO show excellent specific capacitances of 212.67, 160.36, 142.61, 184.167, and 132.45 at various current densities (0.3 to 2 A/g, respectively) as shown in the Table 5. The GCD plots at different current densities are shown in FIG. 12C.

EIS measurements for three-electrode and two-electrode setups are usually relevant however an EIS test is performed for the fabricated SC device using 3D-HPN-rGO as electrode material and AV gel as an electrolyte in the two-electrode setup, further. EIS is utilized mainly to analyze the material's internal resistance and different types of impedance, operating in the frequency range of 10 MHz to 106 Hz. A plot of the real (Z) and imaginary (Z″) impedances (ohms) for a model symmetric two-electrode device is given in FIG. 12D and a rising pattern in the low-frequency region for the model device suggests that manufactured SC device exhibit capacitive behavior. The semi-circle region in the higher frequency range shows that the thick separator and charge transfer interface of the model SC device are accountable for the device's bulk resistance. A semicircle with a straight line at a 90° angle is typically shown on the Nyquist plot. The semicircle shows the charge transfer resistance (Rct) between the electrode and the electrolyte. The line caused by Warburg resistance cuts the real axis at the smallest angle, as can be seen by taking a closer look at the mid-frequency area FIG. 12D suggests that the about ion diffusion paths for electrolyte ions to the pores of the electrode surface. The value of the equivalent series resistance (ESR, Rs) is provided in the higher frequency region to assist in the visualization of the real axis intercept. Using an equivalent circuit model to understand the Nyquist plot, the values of ESR and Rs are also verified in FIG. 12D. The higher value of Rs is found at ˜57.4 ohms which may be because of the various organic constituents present in the electrolyte.

Cyclic stability and percentage capacitance retention: Long-term cyclic stability is one of the supercapacitor's prospective benefits. A cyclic stability test is necessary to confirm and examine an SC device's stability through a large number of cycles of charging and discharging. The SC device can maintain the Cs value of 197.78 Fg-1 even after the 5000 cycles of charge-discharge which is 212.67 Fg-1 at an initial low current density of 0.2 Ag-1 (FIG. 12 E). In terms of percentage capacitance retention, the fabricated SC device can have very high (˜93%) capacity retention as shown in FIG. 12 F.

Power density and energy density: For the fabrication of advanced Supercapacitor devices, energy density is an important aspect that should be enhanced. Equation 5 is used to determine the set-up Supercapacitor device's energy density in Whkg-1. Power density, which can reveal information about the rate of delivery of the energy density, is one of the key factors to consider when evaluating the quality of Supercapacitor devices that have been fabricated. Equation 6 is used to compute the power density. At the lower current density of 0.3 A/g, it can be observed that 3D-HPN-rGO exhibits the highest energy density of ˜23.92 Whkg-1 against a good power density of ˜269.94 Wkg-1 in a total stable voltage of 1.8 V.

FIG. 13 illustrates Table 1 depicts an elemental analysis of the sample via EDX.

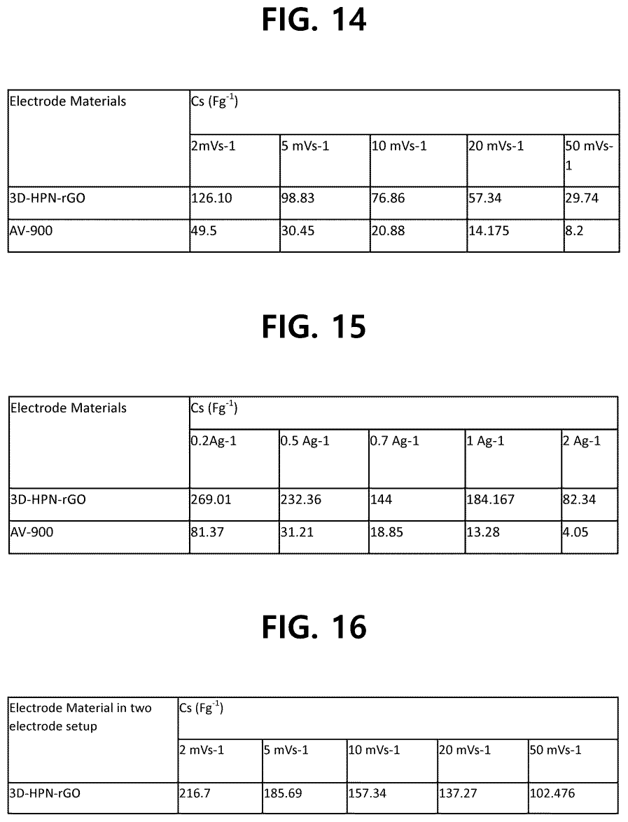

FIG. 14 illustrates Table 2 depicts Cs values of electrode materials at numerous scan rates employing a CV.

FIG. 15 illustrates Table 3 depicts Cs values of electrode materials at different current densities employing a GCD.

FIG. 16 illustrates Table 4 depicts Specific Capacitance values at numerous scan rates in two electrode setups.

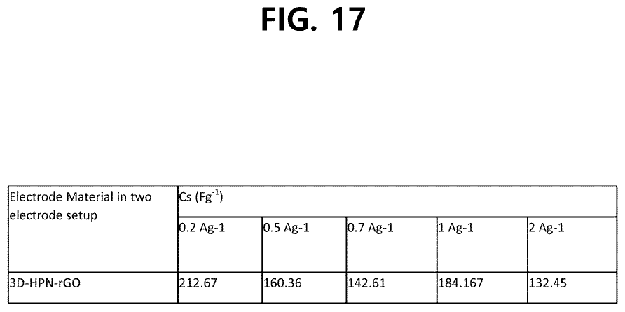

FIG. 17 illustrates Table 5 depicts Specific Capacitance values at numerous current densities in two electrode setups.

Three-dimensional hierarchical porous nitrogen-doped reduced graphene oxide with excellent electrochemical stability is successfully prepared from aloe vera leaf via a two-step pyrolysis technique followed by activation. The introduction of potassium carbonate in the secondary pyrolysis process felicitates activation which results in improved porosity in a 3D hierarchical manner. Furthermore, the aloe vera gel-based electrolyte surpassed the potential range of 1.2 V for aqueous electrolytes and reaches up to 1.8 V. As synthesized 3D-HPN-rGO electrodes exhibit maximum specific capacitance of 269.01 Fg-1 while AV-900 without activation exhibits only 81.37 Fg-1, at 0.2 Ag-1 current density respectively in three-electrode setup using aloe gel electrolyte. In addition, the two-electrode setup displays a maximum specific capacitance value of 212.67 Fg-1 and retains over 132 Fg-1 at a higher current density of 2 Ag-1. In addition, a fabricated SC device shows very stable performance and more than 93% capacitance retention even after 5000 cycles of charging and discharging at a current density of 0.2 Ag-1. SC device fabricated using this greener combination of electrode material and electrolyte shows a maximum energy density of 23.92 Whkg-1 corresponding to the energy density of 269.94 Wkg-1 at 0.2 Ag-1 current density. This work may also suggest the method for the preparation of high-value 3D hierarchical porous carbon-based nanomaterials from any biomass waste and their application in any kind of energy storage device like battery, supercapacitor, etc. It also gives insights for using cost-effective and naturally available, green electrolytes like aloe vera gel-based electrolytes with comparably more electrochemical potential window value than chemical-based aqueous electrolytes which felicitates the energy density of the supercapacitor devices for the practical futuristic greener energy storage technologies.

The present invention includes a greener, ecofriendly, low cost and sustainable approach for energy resources. The present invention includes the successful green synthesis of highly porous graphene-based material by using aloe-vera leaves as precursor via two step pyrolysis method. The present invention includes the use of aloe-vera gel as a green, natural and novel electrolyte for the electrochemical performance study of fabricated cells. The present invention includes aloe gel as a green and novel electrolyte that has a high potential window (1.8V) than other existing aqueous electrolytes (1.23V). The invention embodies aloe-vera-derived graphene-based material as a highly conductive, extremely light weighted material, which is an ingenious invention in the allotropic performance supercapacitor devices using aloe-vera waste-derived graphene nanosheets as electrode material and aloe gel as a novel electrolyte with a potential window of 1.8 V. For the development of eco-friendly and sustainable energy resources, energy storage devices are fabricated and designed by using the synthesized green materials and green novel electrolyte. This invention remedies the current energy crisis problem and also fulfills the need for the development of ecofriendly low cost, green energy resources by synthesizing graphene based material and green electrolyte from aloe-vera leaves. The fabricated device with aloe-vera-derived 3D-HPN-rGO and electrolyte will ensure high capacitance and more than 93% of retention rate. Another embodiment of this invention will include the addition of K2CO3 as an activating agent. In detail the embodiment will include the two-step pyrolysis process including primary pyrolysis at lower temperatures for pre-carbonization of the sample and secondary pyrolysis process with activation at higher temperatures to exfoliate the reduced graphene oxide which then further will be allowed to disperse in the aqueous solution with the help of ultrasonic processor.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above about specific embodiments. However, the benefits, advantages, solutions to problems, and any component(s) that may cause any benefit, advantage, or solution to occur or become more pronounced are not to be construed as a critical, required, or essential feature or component of any or all the claims.

What is claimed is:

1. A method for preparing supercapacitors utilizing three-dimensional hierarchical porous nitrogen-doped reduced graphene oxide (3D-HPN-rGO) derived from aloe vera leaf, the method comprises:
a) processing raw aloe vera leaf and separating aloe vera leaf into an inner gel and an outer green rind;
b) cleaning and drying said outer green rind in sunlight for two days followed by oven drying at 80° C. for about 24 hours;
c) pyrolyzing said dried outer green rind in an inert environment of N2 gas using a Tube furnace apparatus at 400° C. for about 1 hour to obtain a pre-carbonized carbon (AV-C) by pre-carbonization;
d) mixing said AV-C with K2CO3 in a 2:1 impregnation ratio to obtain a mixture;
e) pyrolyzing said mixture of said AV-C and K2CO3 at a temperature of 900° C. in an inert environment of N2 gas;
f) removing resulting black charred residue once said Tube furnace apparatus is cooled and cleaning said resulting charred residue with double-distilled water and isopropyl alcohol;
g) homogenizing said cleaned black material of reduced graphene oxide with ultrasonic energy using an ultrasonic homogenizer at 30% power for 1 hour with 10 pulse rates thereby drying and filtering said reduced graphene oxide to obtain 3D-HPN-rGO;
h) preparing an electrode using said obtained 3D-HPN-rGO; and
i) constructing a supercapacitor device using said electrodes.

2. The method as claimed in claim 1, wherein processing raw aloe vera leaf comprises steps of:
cutting said raw aloe vera leaf into small pieces;
washing said small pieces repeatedly with DI; and
slicing said small pieces into two parts and collecting said Aloe vera gel from both sides to separate said aloe vera leaf into said inner gel and said outer green rind.

3. The method as claimed in claim 1, wherein said pyrolyzing in step c involves gradually pyrolyzing said sample at a heating rate of 50° C./min to remove liquid and gaseous components, wherein said pyrolyzing in step e involves a heating rate of 10° C./min.

4. The method as claimed in claim 1, wherein said pre-carbonization of said sample establishes a framework for an Aloe vera derived rGO with a separation of liquids and gases followed by obtaining black-colored solid after 1 hour of pyrolysis and cooling said Tube furnace apparatus to ambient temperature to extract black material thereby reducing said black material to a fine powder using a mortar and pestle to obtain said AV-C.

5. The method as claimed in claim 1, wherein preparing said electrode using said synthesized 3D-HPN-rGO comprising the steps of:
preparing a paste by mixing 3D-HPN-rGO with 10 wt % PVDF binder dissolved in N-Methyl-2-pyrrolidone (NMP) solvent and mixing thoroughly with a stirrer;
coating graphite sheets with said paste;
drying said coated graphite sheets at 60° C. for about 24 hours.

6. The method as claimed in claim 5, wherein said coated material's weight on said graphite sheet before and after said coating procedure is measured to obtain a coated mass value of 1 mg.

7. The method as claimed in claim 1, wherein constructing a supercapacitor device comprising the steps of:
positioning two dried electrodes in a manner wherein said substance coating faces each other; and
separating said two electrodes using a Millipore filter paper submerged in Aloe vera gel as an electrolyte.

8. The method as claimed in claim 1, wherein said synthesized 3D-HPN-rGO is used in a three-electrode system, wherein said working electrode is said Aloe-vera derived reduced Graphene Oxide material coated on a graphite sheet, a reference electrode is Ag/AgCl, and a counter electrode is a Platinum wire.

9. A system for preparing supercapacitors utilizing three-dimensional hierarchical porous nitrogen-doped reduced graphene oxide (3D-HPN-rGO) derived from aloe vera leaf, the system comprises:
a) a pre-processing unit configured to separate said Aloe vera leaf into an inner gel component and an outer green rind component;
b) a drying unit coupled to said pre-processing unit to subject said outer green rind component to a drying process under sunlight followed by oven drying at 80° C.;
c) a tube furnace apparatus in connection with the said drying unit to perform a two-step pyrolysis process on dried outer green rind;
d) a mortar and pestle in continuation with a tube furnace apparatus adapted for grinding resultant pyrolyzed material to a fine black powder;
e) a mixing unit configured to combine said black powder with K2CO3 in a 2:1impregnation ratio;
f) an ultrasonic homogenizer coupled to said mixing unit to treat said resultant black material at 30% power for 1 hour with 10 pulse rates to produce 3D-HPN-rGO;
g) a coating unit connected to said ultrasonic homogenizer to apply a 10-weight percent PVDF binder in N-methyl pyrrolidone (NMP) solvent onto at least two graphite sheets;
h) a drying unit coupled to said coating unit to allow said coated graphite sheets to dry for 24 hours in an oven set at around 600° C.; and
i) an electrode configuration unit in connection to said drying unit to separate coated material on two graphite sheets by a Millipore filter paper submerged in Aloe vera gel electrolyte to fabricate a supercapacitor.

10. The system as claimed in claim 9, wherein said tube furnace apparatus operates at a heating rate of 50° C./min during said first step of pyrolysis to reach a temperature of 400° C. in an inert environment of N2 gas, wherein said second step of pyrolysis in said tube furnace apparatus operates at a fast-heating rate of 10° C./min to reach a temperature of 900° C. in an N2 environment.
